(19) United States
(12) Patent Application Publication
(10) Pub. No.: US 2017/0276227 A1
(43) Pub. Date: Sep. 28, 2017

(54) PINION FORMED BY TWO JOINABLE PARTS

(71) Applicant: SYSTEM PLAST S.R.L., Telgate (BG) (IT)

(72) Inventors: Markus MULLER, RADEBERG (DE); Francesco ZANI, TORBIATO DI ADRO (BS) (IT); Ted VAN DER HOEVEN, DE LIER (NL)

(21) Appl. No.: 15/466,165

(22) Filed: Mar. 22, 2017

(30) Foreign Application Priority Data
Mar. 23, 2016 (IT) 102016000030286

(51) Int. Cl. F16H 55/12; F16H 55/17

(52) U.S. Cl. CPC F16H 55/12; F16H 55/17; F16H 2055/175

(57) ABSTRACT

Pinion formed by two joinable parts mountable on a shaft includes a substantially semi-circular first portion of the pinion; a substantially semi-circular second portion of the pinion; the first portion has a first joining surface and a first portion of a hole concentric with the pinion; the second portion has a second joining surface and a second portion of a hole concentric with the pinion; the first joining surface is adapted to be joined to the second joining surface by means of connection means; characterized in that the connection means includes a first bushing and a second bushing; the first bushing is fixed onto said first portion and protrudes from the first joining surface; said second bushing is fixed onto the first or second portion and protrudes from the first or second joining surface.

### TECHNICAL FIELD

The present invention relates to a pinion formed by two joinable parts mountable on a shaft and preferably toothed.

### BACKGROUND

As known, pinions formed by two joinable parts are available. The pinions are formed in two parts in order to allow easier mounting and repair, as there is no need to remove the shaft on which they are mounted.

It is necessary for the connection between the two parts to be durable, so that high torque can be applied. In the pinions manufactured in two halves the combination of various stress creates friction forces in the junction thereof which is released on the fixing elements. An insufficient reaction at the outlying part of the wheel can create dimensional deformations under stress.

The profiles of the teeth are not always symmetrical, and therefore it is necessary to not reverse the two halves during the pinion assembly.

The two parts of the pinion are normally fixed one to the other by means of two screws and two nuts.

These bolts are perfectly able to keep the two halves together, but due to the clearance between screw and hole, they cannot absorb the friction forces.

Furthermore, since they are symmetrically arranged, it is possible that the buyer could make an error during the assembly of the pinion.

Another disadvantage of using screws and nuts is the fact that the pinion has two holes for the screws and two holes for the nuts. This is unfavourable from a sanitary point of view, since dirt may clog the holes.

If all the holes are clogged with dirt the head of the screw which allows to remove the pinion, cannot be seen.

Moreover, the holes degrade the profile of the teeth of the pinion.

There is also the risk that the bolt rotates within the hole. If this happens before the installation, the pinion must be thrown away. If it happens after the installation, the pinion must be destroyed in order to be removed from the shaft.

In addition to the bolts small pins are used to ensure that the two halves of the pinion are correctly aligned.

### SUMMARY

The object of the present invention is to provide a pinion formed by two joinable parts which overcomes the drawbacks of the known art.

Another object is to provide a pinion which has a greater degree of absorption of the forces of friction between the two halves.

A further object is to provide an easily installable pinion.

Another object is to provide a pinion which eliminates assembly errors.

A further object is to provide to a pinion which is simple to implement.

According to the present invention, said objects and others are achieved by a pinion formed by two joinable parts which is mountable on a shaft comprising: a substantially semi-circular first portion of said pinion; a substantially semi-circular second portion of said pinion; said first portion has a first joining surface and a first portion of a hole concentric with said pinion; said second portion has a second joining surface and a second portion of a hole concentric with said pinion; said first joining surface is suited to be joined to said second joining surface by means of connection means; characterized in that said connection means comprise a first bushing and a second bushing; said first bushing is fixed on said first portion and protrudes from said first joining surface; said second bushing is fixed on said first or second portion and protrudes from said first or second joining surface.

Additional features of the invention are described in the dependent claims.

The advantages of this solution compared to known solutions are several.

With the present solution the holes for the nuts are no longer needed, but only those of the screws.

As fewer holes are provided (two instead of the four of the prior art) the profiles of the teeth of the pinion are less degraded.

The sanitary aspect is improved.

The screws are easily identified, and no time is lost during the disassembly step.

In case the bushing rotates within the pinion, the latter can always be removed without destroying it and without disassembling the shaft, because the bushing can be unscrewed.

The larger size of the bushings with respect to the pins used in the prior art allows a greater resistance to deformation under stress.

The pins no longer need to be inserted, which are usually inserted by hand with a hammer, making the working environment safer.

### BRIEF DESCRIPTION OF THE DRAWINGS

The characteristics and advantages of the present invention will become apparent from the following detailed description of an embodiment thereof, illustrated by way of non-limiting example in the accompanying drawings, wherein:

FIG. 1 shows a pinion, seen in perspective, according to the present invention;

FIG. 2 shows a pinion, seen partially and in cross section, according to the present invention;

FIG. 3 shows a pinion, seen in a side section, according to the present invention;

FIG. 4 shows a fixing detail of a pinion, seen in a side section, according to the present invention;

FIG. 5 shows a bushing for fixing a pinion, according the present invention.

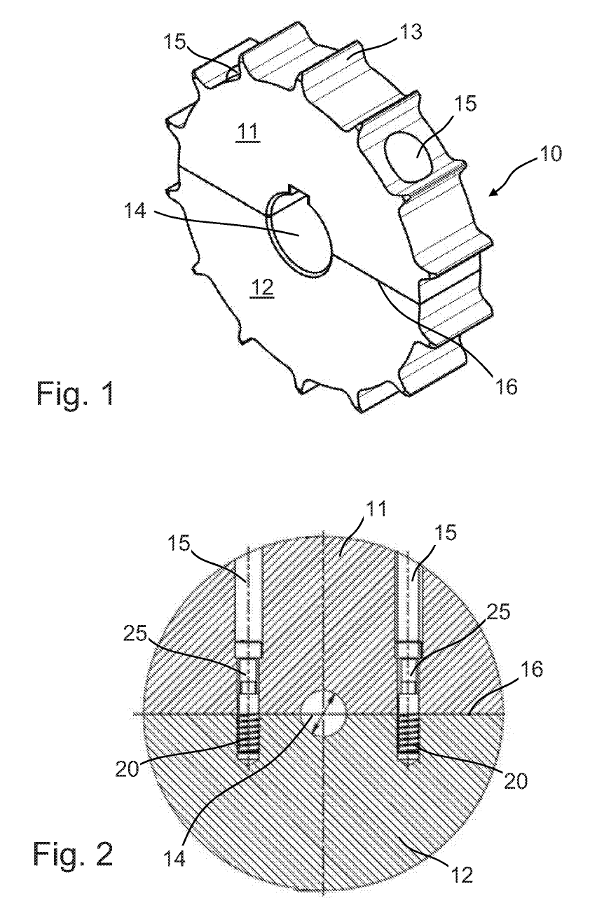

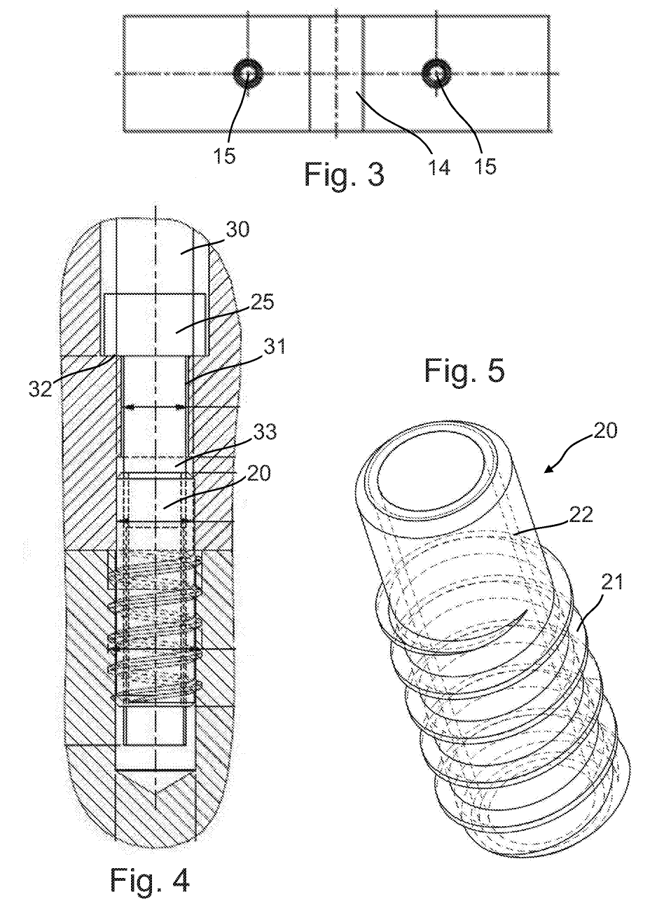

### DETAILED DESCRIPTION

Referring to the attached figures, a pinion 10, according to the present invention, comprises a first semi-circular portion 11 and a second semi-circular portion 12, joined together to form the pinion 10.

The pinion 10 preferably comprises a series of teeth 13 arranged on the external periphery of the same, and a central hole 14 coaxial (concentric) with the pinion 10.

The portion 11 comprises two holes 15 transverse to the axis of the pinion 10, arranged laterally to the hole 14, which, starting from the periphery of the pinion 10, preferably between a tooth 13 and another, reach the joining surfaces 16 of the two portions 11 and 12.

In the portion 12 two bushings 20 are screwed at the side of the hole 14, arranged so that they can be aligned with the corresponding holes 15. The portion 12 is previously prepared to receive the bushing 20.

The two pairs of holes 15 and the corresponding bushings 20 are arranged at the sides of the central hole 14 and approximately at half the distance between the central hole 14 and the outer edge of the pinion 10.

The two pairs of holes 15 and the corresponding bushings 20 are not, however, arranged at the same distance from the central hole 14 but at two different distances, so that the connection is made only in one way and it is not possible to incorrectly couple the two portions 11 and 12.

The bushings 20 have a threaded lower portion 21 and an upper smooth portion 22 on the outside.

The threaded portion 21 is fully screwed into the portion 12, whereas the smooth portion 22 is external to the portion 12, and therefore partially enters into the hole 15.

The bushings 20 are internally hollow and have on the inside a thread suited to receive a screw 25.

The holes 15 have an inner diameter that varies.

Starting from the periphery of the pinion 10 they have a diameter 30, for about half the depth, equal to that of the head of the screw 25, therefore a narrowing in the diameter 31 is provided, equal to that of the screw 25 and so as to form an undercut 32 to lock the head of the screw 25. A further increase in the diameter 33 is provided, which must be equal to the outer diameter of the smooth portion 22 of the bushing 20.

The pinion 10 is normally made of polyamide.

The bushing 20 is made of brass and is typically 40 mm long and has a diameter of 10 mm or 8 mm.

The bushing 20 is substantially cylindrical and the thread 21, is 20 mm long, and protrudes from the cylindrical body by 1.5 mm.

The thread is suitable to be used in plastic materials, of the flat crested type, and the step has a ratio with the width at the base of the thread comprised between 3 to 1 and 4 to 1.

The screws 25 are normally M6 or M8.

In an alternative embodiment, the bushings 20 can be inserted in a first portion 11 and in a second portion 12. The holes 15 therefore will be one in the first portion 11 and one in the second portion 12.

The materials used, as well as the dimensions, of the pinions and of the bushings, may however be any according to the requirements and the state of the art.

1. A pinion formed by two joinable parts which is mountable on a shaft comprising: a substantially semi-circular first portion (12) of said pinion (10); a substantially semi-circular second portion (11) of said pinion; said first portion (12) has a first joining surface (16) and a first portion (14) of a hole concentric with said pinion (10); said second portion (11) has a second joining surface (16) and a second portion (14) of a hole concentric with said pinion (10); said first joining surface (16) is suited to be joined to said second joining surface (16) by means of connection means; characterized in that said connection means comprise a first bushing (20) and a second bushing (20); said first bushing (20) is fixed onto said first portion (12) and protrudes from said first joining surface (16); said second bushing (20) is fixed onto said first (12) or second (11) portion and protrudes from said first or second joining surface (16).

2. The pinion according to claim 1 characterized in that said first portion (12) and said second portion (11) is half pinion and said first and second concentric hole portion is half hole (14).

3. The pinion according to claim 1, characterized in that said first bushing (20) and said second bushing (20) are partially covered by an external thread (21).

4. The pinion according to claim 1, characterized in that said first bushing (20) and said second bushing (20) are partially smooth on the outer portion (22).

5. The pinion according to claim 1, characterized in that said first bushing (20) is screwed into said first portion (12) and said second bushing (20) is screwed into said first (12) or second (11) portion.

6. The pinion according to claim 1, characterized in that said first bushing (20) and said second bushing (20) are hollow and internally threaded.

7. The pinion according to claim 1, characterized in that said first and said second bushing (20) are substantially cylindrical and comprise a flat crested thread (21) on the outside.

8. The pinion according to claim 1, characterized in that said first bushing (20) is fixed onto said first portion (12); said second bushing (20) is fixed onto said first portion (12); a first hole (15) is arranged on said second portion (11) and is aligned with said first bushing (20); a second hole (15) is arranged on said second portion (11) and is aligned with said second bushing (20).

9. The pinion according to claim 1, characterized in that said first bushing (20) and said second bushing (20) are arranged at the sides of said first concentric hole portion (14).

10. The pinion according to claim 1, characterized in that said first bushing (20) is fixed onto said first portion (12) at a distance from said first concentric hole portion (14) different from the distance between said second bushing (20) and said first concentric hole portion (14).

11. The pinion according to claim 1, characterized in that the thread (21) of said first bushing (20) and of said second bushing (20) has a step that has a ratio with the width at the base of the thread comprised between 3 to 1 and 4 to 1.
